(19) United States
(12) Patent Application Publication
(10) Pub. No.: US 2019/0385593 A1
(43) Pub. Date: Dec. 19, 2019

(54) METHOD FOR CONTROLLING THE TRANSMISSION OF DATA BETWEEN AT LEAST ONE HEARING DEVICE AND A PERIPHERAL DEVICE OF A HEARING DEVICE SYSTEM AND AN ASSOCIATED HEARING DEVICE SYSTEM

(71) Applicant: SIVANTOS PTE. LTD., SINGAPORE (SG)

(72) Inventors: GOTTFRIED RUECKERL, NUERNBERG (DE); RICCARDO CAVALLARI, ERLANGEN (DE); STEFAN MIJOVIC, ERLANGEN (DE); RICARDO MORALES RAMOS, ERLANGEN (DE)

(21) Appl. No.: 16/444,085

(22) Filed: Jun. 18, 2019

(30) Foreign Application Priority Data
Jun. 18, 2018 (DE) 10 2018 209 824.7

(51) Int. Cl. G10L 15/08; H04R 3/00; G06F 3/16

(52) U.S. Cl. CPC G10L 15/08; H04R 3/00; H04R 2420/07; G10L 2015/088; G06F 3/167

(57) ABSTRACT

A method controls the transmission of data between at least one hearing device and a peripheral device of a hearing device system. A microphone signal captured by the hearing device is automatically examined for at least one key sequence stored in the hearing device. Wherein, upon the recognition of at least one stored key sequence in the microphone signal, an audio sequence of the microphone signal that follows this key sequence is transmitted from the hearing device to the peripheral device of the hearing device system. The transmission unit here transmits the microphone signal beginning with the key sequence. Furthermore a hearing device system with at least one hearing device is configured for carrying out the method described above.

### CROSS-REFERENCE TO RELATED APPLICATION

This application claims the priority, under 35 U.S.C. § 119, of German application DE 10 2018 209 824.7, filed Jun. 18, 2018; the prior application is herewith incorporated by reference in its entirety.

### BACKGROUND OF THE INVENTION

### Field of the Invention

The invention relates to a method for controlling the transmission of data between at least one hearing device and a peripheral device of a hearing device system. The invention further relates to a hearing device system for carrying out such a method.

The purpose of a hearing device is to provide a person with impaired hearing with acoustic environmental signals that are appropriately processed, and in particular amplified, to compensate for the particular hearing impairment. For this purpose a hearing device usually contains an input transducer in the form, for example, of a microphone, a signal processing unit with an amplifier, and an output transducer. The output transducer is as a rule realized as a miniature loudspeaker, and is also referred to as an earpiece or receiver. In particular it generates acoustic output signals that are guided to the hearing organs of the patient where they generate the desired hearing perception.

Hearing devices with different structural forms are offered in order to meet the large number of individual needs. In the so-called behind-the-ear (BTE) hearing devices, also known in German as Hinter-dem-Ohr or HdO a housing containing components such as a battery and the signal processing unit is worn behind the ear. Depending on the design, the receiver can be arranged directly in the auditory canal of the wearer (so-called receiver-in-canal (RIC) hearing devices). The receiver is, alternatively, arranged inside the housing itself, and a flexible sound tube, also referred to as the tube, guides the acoustic output signals of the receiver from the housing to the auditory canal (tube hearing devices). In in-the-ear (ITE) hearing devices, also known in German as IdO or In-dem-Ohr, a housing that contains all of the functional components, including the microphone and the receiver, is at least partially worn in the auditory canal. completely-in-canal (CIC) hearing devices are similar to the ITE hearing devices, but are worn entirely inside the auditory canal.

In order to allow wireless communication between a hearing device and an external peripheral device such as for example a smartphone, wireless technologies (abbreviated to RF, e.g. Bluetooth, Bluetooth LE or similar technologies) are now often used for transmission. No additional external devices are necessary here for wireless communication.

These wireless technologies offer, for example, the possibility of sending an audio stream (i.e. audio signals) from a hearing device to the peripheral device. This can be done, for example, for the purpose of using a voice control system managed by the peripheral device. The peripheral device here receives the audio stream and passes it on to applications that analyze the audio stream and generate control activities from the voice content of the audio stream (e.g. voice-controlled dialing, opening and closing applications, or the like). Such applications can be implemented locally in the peripheral device or can run externally, for example in a cloud connected to the peripheral device over the Internet.

So that the peripheral device can react reliably to acoustic signals, the microphone sound recorded by the hearing device must be transmitted permanently (continuously) to the peripheral device over the wireless RF connection. Continuous data transmission, however, raises the data traffic on the wireless RF connection, and thereby also the current consumption of the hearing device, considerably. This has, for example, a negative effect on the battery life of the hearing device (or, in the case of rechargeable batteries, on the operating duration of the hearing device with one battery charge).

### SUMMARY OF THE INVENTION

The invention is therefore based on the object of providing an efficient and energy-saving facility for the transmission of recorded sound signals from a hearing device to a peripheral device.

The method according to the invention is used for controlling the transmission of data between at least one hearing device and a peripheral device of a hearing device system. In the context of the method, a microphone signal captured by the hearing device is automatically examined for at least one key sequence stored in the hearing device. Upon the recognition of at least the stored key sequence (or one of what may be a plurality of stored key sequences) in the microphone signal, an audio sequence of the microphone signal that follows this key sequence is transmitted from the hearing device to the peripheral device of the hearing device system.

In other words, the audio stream (i.e. the transmission of the microphone signal) from the hearing device to the peripheral device is only activated when at least one key sequence relevant to transmission is recognized in the microphone signal. Only then is the audio sequence of the microphone signal that follows the key sequence transmitted to the peripheral device. This limits the activity of the hearing device and reduces the current consumption of the hearing device components, since the signal transmission only takes place when this is actually required or is desired by the hearing device wearer. The individual method steps take place in particular automatically. The method is preferably employed for control of the data transmission between two hearing devices of a binaural hearing device system and a peripheral device.

In terms of its physical nature, the microphone signal recorded by the (or each) microphone of the hearing device is an audio signal, i.e. an electrical signal that transports sound information. If the stored key sequence (or one of a plurality of stored key sequences) is recognized in the microphone signal, the transmission of the microphone signal to the peripheral device begins. The recognized key sequence thus represents a start sequence through which the time at which the signal transmission from the hearing device to the peripheral device starts is specified. The transmitted audio sequence can here contain the full information depth of the microphone signal, i.e. all the acoustic information contained in the microphone signal during the period of transmission (e.g. situation-related environmental noises, music, speech). Thus in this case the microphone signal is transmitted from the hearing device to the peripheral device in an unfiltered or unprocessed form. As an alternative to this the transmitted audio sequence can, however, also contain the microphone signal in a filtered or preprocessed form. The transmitted audio sequence contains, for example, a lower proportion of noise or a reduced spectral width in comparison with the original microphone signal.

The audio sequence of the microphone signal transmitted from the hearing device to the peripheral device is, in particular, a speech stream, i.e. an audio signal (or a part of such a signal) that contains separable, spoken language. Audio signals, or sections of audio signals, that only contain non-speech sounds (for example music, traffic noise, noises) and/or non-separable speech components (for example speech babble in assemblies of people such as at a cocktail party) are to be distinguished from such a speech stream. The term “speech stream” in other words characterizes a subtype of the acoustic information that is transported in the microphone signal.

In terms of the invention, a key sequence is a section of the microphone signal whose acoustic information transports a specific meaning (in particular a meaning that triggers or requests an action). A key sequence can contain “classic” voice signals such as words or word sequences, or also individual tones or tone sequences such as, for example, signal tones or melodies. A combination of speech and non-speech information (e.g. a word sung at a particular pitch or tone sequence) is also, in principle, conceivable as a key sequence.

According to the invention, in addition to the audio sequence of the microphone signal that follows the key sequence, the key sequence itself (or, put more precisely, the section of the unfiltered or filtered microphone signal that corresponds to the key sequence) is also transmitted to the peripheral device. In other words, the microphone signal is transmitted from the hearing device to the peripheral device starting with the key sequence. The audio sequence that follows the key sequence is here in particular transmitted with a time delay following the key sequence.

In principle, any device that can be coupled to a hearing device for data transmission can be used as the peripheral device. Bluetooth-capable peripheral devices are, in particular, employed. It is particularly preferred if a smartphone is employed as the peripheral device as a part of the hearing device system.

Advantageously, transmission of the audio stream from the hearing device to the peripheral device of the hearing device system is initiated when the at least one recognized key sequence corresponds to a key sequence that is used by an audio-signal processing function of the peripheral device. In other words, the data transmission between the hearing device and the peripheral device is only activated when a correspondence has been established between the at least one key sequence recognized in the microphone signal and a key sequence stored in the peripheral device. The microphone signal is particularly preferably transmitted from the hearing device to the peripheral device when at least one of the key sequences stored in the hearing device corresponds to a key sequence that is also used by a speech-processing function of the peripheral device.

This is explained by way of example with reference to a hearing device system that contains a hearing device to which a smartphone with an Android operating system is coupled. In this case, the signal processing unit of the hearing device can search in the microphone signal for the keywords (key sequence) “OK Google”, for example. Since the smartphone requires the same key sequence—that is, again, the word sequence “OK Google”—for example to start apps installed on it or to open websites, a sufficiently long part of the audio signal (e.g. up to 3 seconds) recognized in the microphone signal is preferably recorded by the hearing device. Upon recognition of the key sequence “OK Google” in the recorded audio signal, the hearing device activates the connection to the smartphone and streams the microphone signal (which can be a speech stream or, for example, also a piece of music) to the smartphone. The recorded key sequence, i.e. the words “OK Google” contained in the microphone signal, are then sent to the smartphone together with the subsequent audio sequence of the microphone signal, so that the voice recognition program running on the smartphone is also activated by this key sequence.

The key sequence is, in particular, a key sequence external to the hearing device (that is a key sequence that otherwise does not have any significance for the function of the hearing device itself). The key sequence is, in particular, a specific tone or a specific tone sequence (for example a jingle) or, however, a specific password (keyword) for activating services or applications on the respective peripheral device (for example, “OK Google”).

In an advantageous embodiment, the microphone signal is stored temporarily in the hearing device, in particular in order to enable a time-delayed transmission to the peripheral device. Preferably here a sliding section of the recorded microphone signal, e.g. the last 3, 5 or 10 seconds of the microphone signal, is continuously stored temporarily during operation of the hearing device. Upon recognition of the key sequence in the current microphone signal, the temporarily stored microphone signal is preferably here transmitted, with a fixed or adjustable time delay, to the peripheral device instead of the current microphone signal.

Preferably the at least one recognized key sequence and the subsequent audio sequence of the microphone signal are transmitted wirelessly from the hearing device to the peripheral device. In particular, the at least one recognized key sequence and the subsequent audio sequence of the microphone signal are transmitted by means of an electrically efficient RF transmission system. The transmission takes place particularly preferably by means of Bluetooth LE (BLE), which has a lower current consumption in comparison with “classic” Bluetooth.

The transmission of the microphone signal from the hearing device to the peripheral device is preferably done depending on own voice detection. Upon recognition of the key sequence, the microphone signal is thus only transmitted if the key sequence has been verified as a sequence spoken in the own voice of a hearing device wearer. The key sequence is preferably a voice command (in principle, however, in the context of this variant embodiment, one or a plurality of tones sung or hummed by the hearing device wearer could also be verified as a key sequence). Other audio signals such as, for example, speech signals from conversation partners or from a radio playing in the background, that are recorded by the microphone of the hearing device do not, on the other hand, initiate audio transmission to the peripheral device in this form of embodiment.

It is further preferred for the transmission of the microphone signal from the hearing device to the peripheral device to be ended when a stored termination sequence is recognized in the microphone signal. The recognition of the termination sequence in the microphone signal here takes place analogously to (and preferably with the same means as) the recognition of the key sequence, or any of the key sequences, that trigger the transmission. In a termination sequence internal to the hearing device, the word sequence “Stop, SIGNIA” can, for example, lead to a termination of the data transmission. This can be achieved with termination sequences external to the hearing device through, for example, the speech command “Stop, Google”. It is also preferred for the transmission of the microphone signal from the hearing device to the peripheral device to be ended when at least one of the termination sequences stored in the hearing device has been verified in the microphone signal as being spoken with the own voice of a hearing device wearer. In this case, only the hearing device wearer himself can stop the data transmission. As an alternative to this it is provided that the data transmission is automatically stopped by the hearing device when the hearing device wearer is vocally inactive for a specific period of time, i.e. does not speak.

The hearing device system according to the invention contains at least one hearing device which, in turn, contains the following components: at least one microphone for recording a microphone signal; a signal processing unit (in particular in the form of a digital signal processor, abbreviated to DSP) for examining the microphone signal for at least one key sequence stored in the (or in each) hearing device; as well as a transmission unit which is arranged for transmission of an audio sequence of the microphone signal subsequent to the key sequence from the hearing device to a peripheral device upon recognition of the stored key sequence in the microphone signal.

The transmission unit here also additionally transmits the key sequence recognized in the microphone signal. The transmission unit is thus arranged to transmit the microphone signal beginning with the key sequence from the hearing device to the peripheral device.

The hearing device system according to the invention is thus generally arranged for carrying out the method described above. The transmission of the microphone signal from the (or from each) hearing device to the peripheral device described above only takes place here when the key sequence (or one of a plurality of stored key sequences) has been recognized in the microphone signal by means of the signal processing unit. The forms of embodiment of the method according to the invention described above correspond respectively to corresponding forms of embodiment of the hearing device system according to the invention.

The hearing device system comprises in particular two hearing devices that are arranged to supply the two ears of the hearing device wearer. In this case it is a binaural hearing device system. The two hearing devices of the hearing device system are here expediently coupled by a magnetic link, wherein the algorithms underlying the own voice recognition (OVD algorithms) can exchange data between both hearing devices over this link.

The signal processing unit of the hearing device preferably contains an audio signal recognition module which permanently analyzes the microphone signal, and from this recognizes at least one key sequence stored in the hearing device. The audio signal recognition module preferably contains at least one algorithm for recognizing tones and/or tone sequences. Additionally, or as an alternative to this, the audio signal recognition module preferably contains at least one algorithm for voice recognition.

Preferably the at least one hearing device is arranged for wireless transmission of the at least one recognized key sequence and the subsequent audio sequence of the microphone signal from the respective hearing device to the peripheral device. The at least one hearing device expediently contains RF transmission electronics including an RF antenna.

Other features which are considered as characteristic for the invention are set forth in the appended claims.

Although the invention is illustrated and described herein as embodied in a method for controlling the transmission of data between at least one hearing device and a peripheral device of a hearing device system and an associated hearing device system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of a hearing device system with a hearing device and a smartphone as peripheral device according to the invention; and

FIG. 2 is a flowchart showing a progress of the method for data transmission between a hearing device and a peripheral device.

### DETAILED DESCRIPTION OF THE INVENTION

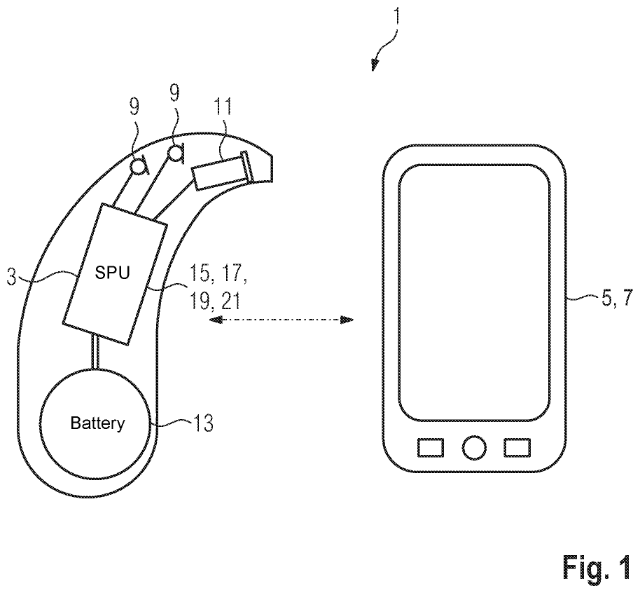

Referring now to the figures of the drawings in detail and first, particularly to FIG. 1 thereof, there is shown a schematic illustration of a hearing device system 1 with a hearing device 3 and a peripheral device 7 in the form of a smartphone 5. The hearing device 3 contains two microphones 9, an earpiece or receiver 11, and a battery 13. The hearing device 3 further contains a signal processing unit 15 in the form of a digital signal processor (DSP) with an audio recognition unit 17 and a transmission unit 19. The signal processing unit 15 is preferably a hardware component with non-programmable integrated circuits (in particular an ASIC). In this case, the audio recognition unit 17 and/or the transmission unit 19 are preferably implemented in the form of non-programmable circuits. As an alternative to this, the signal processing unit 15 is formed by a programmable processor or contains at least one such processor. In this case the audio recognition unit 17 and/or the transmission unit 19 can also be configured as software modules. The hearing device 3 is connected to the smartphone 5 over low-current RF transmission technology, so that a transmission of data can take place between the two components of the hearing device system 1. The data transmitted from the hearing device 3 to the smartphone 5 here contains audio signals, namely sequences of the microphone signal recorded by the hearing device 3.

The data transmission between the hearing device 3 and the smartphone 5 is only initiated when one of a plurality of key sequences that are stored in the hearing device 3 are identified in the microphone signal recorded by the hearing device 3. In the context of the invention, the term key sequence here refers on the one hand to tones or tone sequences and, on the other hand, to keywords or sequences of keywords.

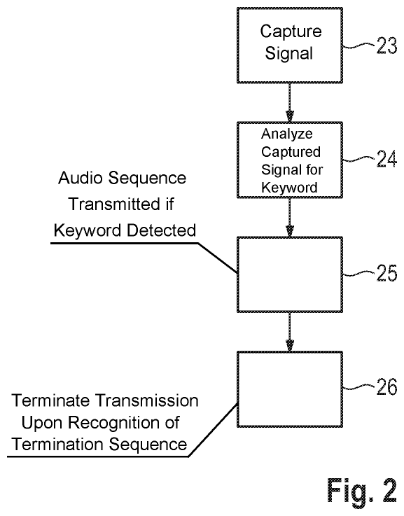

The detailed process flow of the data transmission described above between the hearing device 3 and the smartphone 5 is shown in FIG. 2. Reference is made here to the hearing device system 1 according to FIG. 1 described earlier. Nevertheless, hearing devices and/or peripheral devices of different design can however also be employed for data transmission in accordance with the method described below.

In the course of the method, a microphone signal from the microphones 9 of the hearing device 3 is captured (step 23). At all times the most recent three seconds of the microphone signal are here continuously stored temporarily in a memory of the hearing device 3. The captured microphone signal is analyzed continuously by means of the audio recognition unit 17 and examined for key sequences stored in the hearing device 3 (step 24). In the present case a search is for example made as a key sequence for the word sequence “OK Google” (as a keyword external to the hearing device) which is stored in the hearing device 3. The audio recognition unit 17 contains a voice recognition module 21 for this purpose.

If the word sequence “OK Google” is recognized as an element of the microphone signal, then an audio sequence of the microphone signal that follows this word sequence (i.e. the key sequence) is transmitted by the transmission unit 19 of the hearing device 3 from this to the smartphone 5 (step 25). Instead of the current microphone signal, the temporarily stored microphone signal is here transmitted with a time delay of e.g. 3 seconds. Through the time-delayed transmission, the inclusion of the recognized key sequence (or, more precisely, a section of the microphone signal corresponding to the key sequence) in the transmission is easily achieved if the transmission is started at the point in time at which the key sequence is recognized. The audio signals transmitted to the smartphone 5 thus contains, in the above example, the spoken words “OK Google” that are contained in the microphone signal and that have triggered the transmission.

In a preferred variant embodiment of the hearing device 3 the microphone signal is only transmitted from the hearing device 3 to the smartphone 5 when the word sequence (key sequence) recognized in the microphone signal has been verified as having been spoken in the own voice of a hearing device 3 wearer (“Own Voice Detection”). It is also possible that the speech stream is only transmitted when the word sequence “OK Google” is also used on the smartphone 5 by a function of the peripheral device 5 that processes audio signals, and the key sequences thus match.

The transmitted audio sequence (i.e. the transmission of the microphone signal from the hearing device 3 to the peripheral device 3) is ended when a termination sequence is recognized by the hearing device 3 in the microphone signal (step 26). The word sequence “Stop Google” is, for example, stored as a termination sequence. Here again, the own voice recognition and/or a check between a matching word sequence on the smartphone 5 and the hearing device 3 can also be used.

In a further form of embodiment, not explicitly illustrated, the hearing device system 1 comprises two hearing devices 3. This involves a binaural hearing device system 1 in which the two hearing devices 3 serve to supply the right-hand and left-hand ears of the hearing device wearer, and are coupled to one another via a magnetic link. The algorithms underlying the own voice recognition (OVD algorithms) are used by both hearing devices 3. The OVD algorithms of the two hearing devices 3 here exchange recognition-relevant data over the magnetic link, and improve the reliability of the own voice recognition through suitable processing of this data. The explanations made relating to the hearing device system 1 with a hearing device 3 can here be transferred analogously to the binaural hearing device system 1.

The invention is made particularly clear through the exemplary embodiments described here, but is nevertheless, however, not restricted to these exemplary embodiments. Rather can further forms of embodiment of the invention be derived from the claims and the above description.

The following is a summary list of reference numerals and the corresponding structure used in the above description of the invention:
1 Hearing device system
3 Hearing device
5 Peripheral device
7 Smartphone
9 Microphone
11 Receiver
13 Battery
15 Signal processing unit
17 Audio signal recognition unit
19 Transmission unit
21 Voice recognition module
23 Method step 1
24 Method step 2
25 Method step 3
26 Method step 4

1. A method for controlling a transmission of data between at least one hearing device and a peripheral device of a hearing device system, which comprises the steps of:
automatically examining a microphone signal captured by the hearing device for key sequences stored in the hearing device; and
transmitting an audio sequence of the microphone signal that follows a key sequence from the hearing device to the peripheral device of the hearing device system upon recognition of at least one stored key sequence in the microphone signal, the audio sequence is transmitted from the at least one hearing device to the peripheral device and includes parts of the microphone signal that begins with and follows the key sequence.

2. The method according to claim 1, wherein the microphone signal is only transmitted from the hearing device to the peripheral device when the at least one stored key sequence recognized corresponds to a key sequence that is used by an audio-signal processing function of the peripheral device.

3. The method according to claim 1, which further comprises temporarily storing the microphone signal in the hearing device system.

4. The method according to claim 1, which further comprises transmitting wirelessly the microphone signal from the hearing device to the peripheral device.

5. The method according to claim 1, which further comprises transmitting the microphone signal only from the hearing device to the peripheral device when the at least one stored key sequence recognized has been verified as a sequence spoken in an own voice of a hearing device wearer.

6. The method according to claim 1, which further comprises ending a transmission of the microphone signal from the hearing device to the peripheral device when a termination sequence is recognized in the microphone signal.

7. A hearing device system, comprising:
a peripheral device; and
at least one hearing device, containing:
at least one microphone for recording a microphone signal;
a signal processing unit for examining the microphone signal for at least one key sequence stored in said hearing device; and
a transmission unit configured for transmitting an audio sequence of the microphone signal subsequent to the key sequence from the hearing device to said peripheral device upon recognition of at least one key sequence in the microphone signal, said transmission unit configured to transmit the microphone signal beginning with the key sequence from said at least one hearing device to said peripheral device.

8. The hearing device system according to claim 7, wherein said transmission unit is configured only to transmit the microphone signal from said hearing device to said peripheral device when the at least one key sequence recognized corresponds to a key sequence that is used by an audio-signal processing function of said peripheral device.

9. The hearing device system according to claim 7, wherein said at least one hearing device is configured for intermediate storage of the audio signal.

10. The hearing device system according to claim 7, wherein said at least one hearing device is configured for wireless transmission of the microphone signal from said hearing device to said peripheral device.

11. The hearing device system according to claim 7, wherein said transmission unit is configured only to transmit the microphone signal from said hearing device to said peripheral device when the at least one key sequence recognized has been verified as a sequence spoken in an own voice of a hearing device wearer.

12. The hearing device system according to claim 7, wherein said transmission unit is configured to end a transmission of the microphone signal from said hearing device to said peripheral device upon recognition of at least one termination sequence contained in the microphone signal.
